(19) United States
(12) Patent Application Publication
(10) Pub. No.: US 2004/0069524 A1
(43) Pub. Date: Apr. 15, 2004

(54) High voltage cable and method of fabrication therefor

(76) Inventor: Mark D. Beauchamp, St-Hubert (CA)

Correspondence Address: ORUM & ROTH, 53 W. JACKSON BLVD, CHICAGO, IL, 60604, US

(21) Appl. No.: 10/340,294

(22) Filed: Jan. 10, 2003

(30) Foreign Application Priority Data
Oct. 15, 2002 (CA) 2,408,111

(51) Int. Cl. H01B 7/00

(52) U.S. Cl. 174/110 R

(57) ABSTRACT

The invention provides a cable, and method of fabrication thereof, for use in neon signs, gas-tube signs and ignition systems, comprising an inner insulation coating over the conductor wire, the inner insulation coating being made in a fluoropolymer; and an insulation outer jacket over the inner insulation, the insulation outer jacket being made in a flame retardant rubber; wherein the cable has a total average thickness of about 105 mils (2.667 mm) and a minimum thickness at any point thereof of about 94 mils (2,387 mm).

### FIELD OF THE INVENTION

The present invention relates to high voltage cables. More specifically, the present invention is concerned with high voltage cables of a controlled diameter.

### BACKGROUND OF THE INVENTION

In the field of neon signs, gas-tube signs and ignition circuits for example, high voltage cables are required to meet specific standards, such as the UL Standards in the United States or the CSA Standards in Canada, at temperature ratings higher than 125° C. of temperature ratings. In particular, such cables must be insulated and safe against fire. Moreover, since they may be used in high-voltage parts of electronic appliances submitted to direct current of so high a voltage of 10 kV AC to 40 kV AC, safety against high voltage is also important.

A number of solutions are known to meet the above requirements. For example, double layered cables comprising an inner polyethylene insulation and an outer flame retardant resin composition have been employed. Single layered high-voltage lead cables provided with a flame retardant insulation like a chlorinated polyethylene have also been used. However, such cables cannot be used at temperatures higher than 105° C.

Generally, the high-voltage lead wires used in an environment at higher than 150° C. are wires provided with a vulcanized silicon rubber. However, silicon rubber insulated cables are expensive. Efforts have been made to overcome these problems.

For instance, in U.S. Pat. No. 5,470,657 and European Patent EP 0 536 423, Hayami discloses a heat-resistant high voltage lead wire for direct current between 10 and 40 kV with a temperature rating at 125° C., comprising a conductor provided with an a single or double insulating coating in a polyolefin resin composition irradiated by means of ionizing radiation. Tondre et al., in U.S. Pat. No. 4,678,709, describe a high voltage cable comprising a conductor, an inner layer of an annular cross-section of a thickness comprised between 3 and 15 mils, and an outer layer of an annular cross-section of a thickness also comprised between 3 and 15 mils. Miyamoto et al., in U.S. Pat. No. 4,375,632, present a high voltage ignition cable comprising a multi-layer core conductor, an insulator layer and a jacket. The high voltage cable (30-40 kV) disclosed by Krackeler et al. in U.S. Pat. No. 3,900,533 comprises a primary coating of 15 to 50 mils and a secondary coating in a fluoropolymer of a thickness comprised between 15 and 30 mils.

However, the requirements for the use of high-voltage cables are increasingly severe since the size of electronic appliances have become smaller. As a consequence, currently available high voltage cables have a diameter usually inconveniently large for handling in wiring operations.

From the foregoing, there is a need in the art for improved high-voltage cables.

### OBJECTS OF THE INVENTION

An object of the present invention is therefore to provide a high voltage cable of a controlled diameter and a method of fabrication thereof.

### SUMMARY OF THE INVENTION

More specifically, in accordance with the present invention, there is provided a high voltage cable comprising a resistive-conductor wire, an inner insulation coating over the conductor wire, and an insulation outer jacket over the inner insulation coating, wherein the inner insulation coating allows the high voltage cable to pass tests at a voltage comprised between 15 000 Volts AC and 36 000 Volts AC and have a total average thickness of about 105 mils (2.667 mm) and a minimum thickness at any point thereof of about 94 mils (2,387 mm).

There is therefore provided a cable for use in neon signs, gas-tube signs and ignition systems, comprising an inner insulation coating over the conductor wire, the inner insulation coating being made in a fluoropolymer; and an insulation outer jacket over the inner insulation, the insulation outer jacket being made in a flame retardant rubber; wherein the cable has a total average thickness of about 105 mils (2.667 mm) and a minimum thickness at any point thereof of about 94 mils (2,387 mm).

There is further provided a method for fabricating high voltage cables passing tests at a voltage higher than 20000 volts AC and have a total average thickness of about 105 mils (2.667 mm) and a minimum thickness at any point thereof of about 94 mils (2,387 mm) comprising:

providing a resistive-conductor core;

extruding an inner insulation coating over the resistive-conductor core; and

extruding an outer insulator jacket over the inner insulation coating.

Other objects, advantages and features of the present invention will become more apparent upon reading of the following non-restrictive description of preferred embodiments thereof, given by way of example only with reference to the accompanying drawings.

### BRIEF DESCRIPTION OF THE DRAWING

In the appended drawing:

FIG. 1 is a fragmentary perspective view of a cable according to an embodiment of the present invention; and

FIG. 2 is a flowchart of a method for producing the cable of FIG. 1 according to a second aspect of the present invention.

### DESCRIPTION OF THE PREFERRED EMBODIMENT

Generally stated, the present invention provides a cable comprising a conductor wire provided with an inner insulation coating made in a fluoropolymer, and a conventional insulation outer jacket of flame retardant silicon rubber.

More specifically, the provision of the fluoropolymer coating allows the cable to pass tests at higher voltages, while keeping a reduced diameter thereof.

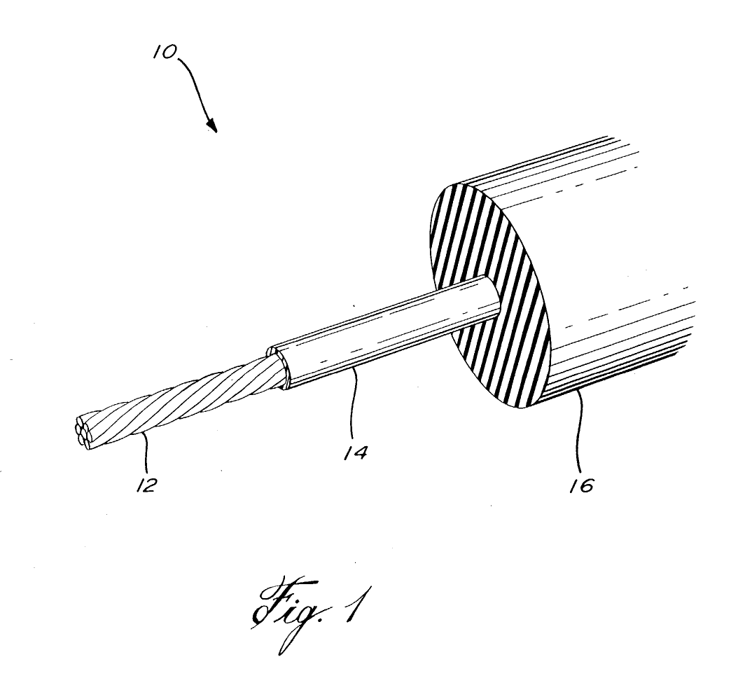

A high voltage cable 10 according to the present invention is illustrated in FIG. 1 of the appended drawings. It comprises a resistive-conductor core 12, an inner insulation coating 14 and an outer insulator jacket 16.

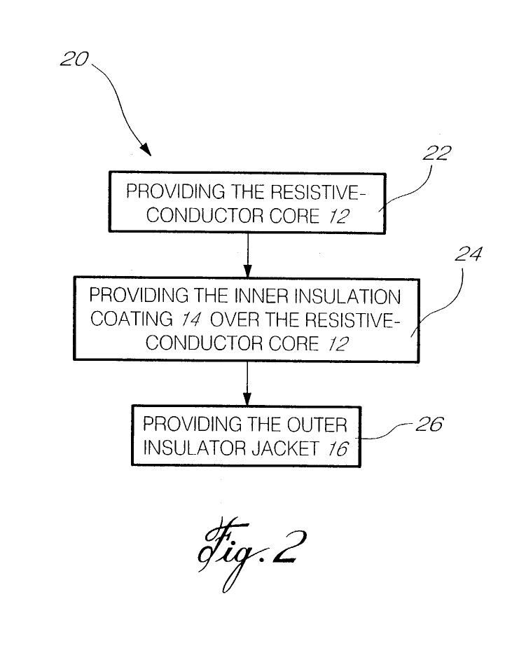

FIG. 2 is a flowchart of a method 20 for producing the cable 10 of FIG. 1 according to a second aspect of the present invention.

Generally described, the method 20 comprises the following steps:

step 22: providing the resistive-conductor core 12;

step 24: extruding the inner insulation coating 14 over the resistive-conductor core 12; and

step 26: extruding the outer insulator jacket 16.

In step 22, the resistive-conductor core 12 is generally commercially available and made of soft annealed ETP copper (stands for electrolytic tough pitch copper) (to comply with ASTM B5 requirement) and plated with 0.75% nominal of high purity tin (following ASTM B339 requirements), for example. ETP copper is a commercially pure, high-conductivity copper, which is refined by electrolytic deposition, then melted, oxidized and brought to tough pitch or controlled low-oxygen content. It is t be noted that a multi-wire resistive-conductor core 12 as illustrated in FIG. 1 allows an increased flexibility, but that a solid core could be also used.

In step 24, the inner insulation coating 14 is extruded out of a fluoropolymer, such as an ethylene-tetrafluoroethylene (ETFE) compound, Tefzel ETFE or Teflon™ for example, which are materials that provide flexibility, allow retention of properties after ageing at elevated temperatures, have a high limiting oxygen index and a long-term service life at higher temperatures. In the cable of FIG. 1, Tefzel 750 rated 150° C and supplied by Dupont is used, with an average thickness of about 5 mils (0.128 mm), and a minimum thickness at any point of about 4 mils (0.102 mm).

In step 26, the outer insulator jacket 16 is extruded of a flame retardant silicone, such as a compound CS-9605-T rated 150° C. manufactured by Cri-Sil, and has an average thickness of 100 mils (2.54 mm), and a minimum thickness at any point of about 90 mils (2.28 mm).

The insulation of the cables of the present invention provides a combination of physical and electrical properties. The outer insulator jacket 16 provides a protection against environmental damages. The inner insulation coating 14 is more flexible than the outer insulator jacket 16 and provides a continuous insulation

Such a cable 10 passes tests at voltages higher than 36 kV ac, while the diameter thereof is similar to that of cables designed to pass tests at 25 kV ac, and comprised between 4 and 5 mils (0.128 mm). People in the art will appreciate that it may be used in neon signs, gas-tube signs and ignition systems, for example.

A number of tests have been carried out on such cables. The results of a physical properties study are displayed in Table 1 below:

TABLE 1

| | | After aging in | After aging in |
|---|---|---|---|
| | | oven for 7 days at | over for 60 days |
| | Unaged | 180° C. | at 158° C. |
| Average tensile | 5980 | 6725 Psi | 6.5 MPa |
| strength (lbf/in²) | | | |
| Average | 280 | 380 | 222 |
| elongation (%) | | | |

Extended voltage application were achieved under a number of test conditions, such as the following: 720 hours under a Xenon arc (sunlight resistance) and water spray; ozone exposure; seven days in water at 75° C.; 4 hours at −25° C. around a mandrel.

The abrasion properties were tested to comply with CSA Standard C22.2 NO: 127-99, by submitting to 1235 cycles with a 7.5%, 60 grit of emery cloth with 4.5 kg weight.

It is therefore found that the method 20 described hereinabove allows to manufacture cables that comply with US standard for gas tube signs and ignition cables UL 814 or Canadian standard CSA related to equipment/lead wire, C22.2 No. 127 for example. These cables therefore pass tests of 30000 volts RMS

Although the present invention has been described hereinabove by way of a preferred embodiment thereof, it can be modified, without departing from the spirit and nature of the subject invention as defined in the appended claims.

What is claimed is:

1. A high voltage cable comprising a conductor wire, an inner insulation coating over said conductor wire, and an insulation outer jacket over said inner insulation coating, wherein said inner insulation coating allows said high voltage cable to pass tests at a voltage comprised between 15 000 volts AC and 36 000 V AC and has a total average thickness of about 105 mils (2.667 mm) and a minimum thickness at any point thereof of about 94 mils (2,387 mm).

2. The high voltage cable according to claim 1, wherein said inner insulation coating allows said high voltage cable to pass tests at 36000 volts AC.

3. The high voltage cable according to claim 1, wherein said inner insulation coating is made in a fluoropolymer.

4. The high voltage cable according to claim 3, wherein said inner insulation coating is selected in the group comprising ethylene-tetrafluoroethylene (ETFE), Tefzel ETFE and Teflon™.

5. The high voltage cable according to claim 4, wherein said inner insulation coating has an average thickness of about 5 mils (0.128 mm), and a minimum thickness of about 4 mils (0.102 mm).

6. The high voltage cable according to claim 1, wherein said insulation outer jacket is made of a flame retardant silicone rubber.

7. The high voltage cable according to claim 6, wherein said insulation outer jacket has an average thickness of about 100 mils (2.54 mm), and a minimum thickness of about 90 mils (2.28 mm).

8. The high voltage cable according to claim 1, wherein said conductor wire is selected in the group comprising a multi-wire conductor and a solid wire conductor.

9. A cable for use in neon signs, gas-tube signs and ignition systems, comprising an inner insulation coating extruded over said conductor wire, said inner insulation coating being made in a fluoropolymer; and an insulation outer jacket over said inner insulation, said insulation outer jacket being extruded out of a flame retardant rubber; wherein said cable has a total average thickness of about 105 mils (2.667 mm) and a minimum thickness at any point thereof of about 94 mils (2,387 mm).

10. A method for fabricating high voltage cables passing tests at a voltage comprised between 15 000 volts AC and 36 000 V AC and having a diameter less than 5 mils (0.128 mm) comprising the acts of:
providing a resistive-conductor core;
extruding an inner insulation coating over the resistive-conductor core; and
extruding an outer insulator jacket over the inner insulation coating.

11. The method according to claim 10, wherein said providing a resistive-conductor core comprises providing a resistive-conductor core made of soft annealed ETP copper plated with 0.75% nominal high purity tin.

12. The method according to claim 11, wherein said providing a resistive-conductor core further comprises providing a conductor core selected in the group comprising a multi-wire resistive-conductor core and a solid resistive-conductor core.

13. The method according to claim 10, wherein said extruding an inner insulation coating over the resistive-conductor core comprises extruding an inner insulation coating made of a fluoropolymer, with an average thickness of about 5 mils (0.128 mm), and a minimum thickness at any point of about 4 mils (0.102 mm).

14. The method according to claim 10, wherein said extruding an outer insulator jacket over the inner insulation coating comprises extruding an outer insulator jacket made of a flame retardant silicone having an average thickness of about 100 mils (2.54 mm), and a minimum thickness at any point of about 90 mils (2.28 mm).
